(19) United States
(12) Patent Application Publication
(10) Pub. No.: US 2016/0271778 A1
(43) Pub. Date: Sep. 22, 2016

(54) Fixing Structure for Cylinder

(71) Applicant: Chih Kuan Hsieh, Hemei Township (TW)

(72) Inventor: Chih Kuan Hsieh, Hemei Township (TW)

(21) Appl. No.: 14/664,821

(22) Filed: Mar. 21, 2015

(51) Int. Cl. B25D 9/04

(52) U.S. Cl. CPC B25D 9/04

(57) ABSTRACT

A fixing structure for a cylinder is employed to a pneumatic tool, and the pneumatic tool contains: a body, a valve unit, a cylinder, a piston member, and at least one positioning element. The body includes a cylindrical portion and a grip, the cylindrical portion has a chamber with an opening, and the cylindrical portion has at least one orifice. The valve unit is mounted in the chamber, and the cylinder is secured in the chamber to contact with the valve unit and includes a room and at least one locking notch. The piston member is placed into the room to push high pressure air to flow along the room. The at least one positioning element is inserted into each orifice of the cylindrical portion, such that a part of each positioning element retains with each locking notch, thus fixing the cylinder with the cylindrical portion.

### BACKGROUND OF THE INVENTION

1. Field of the Invention

The present invention relates to a fixing structure, and more particularly to a fixing structure for a cylinder of a pneumatic tool.

2. Description of the Prior Art

A conventional pneumatic tool is driven by a high pressure air used as a power source. With reference to FIG. 11, the conventional pneumatic tool contains: a grip 10, a valve unit 20, a cylinder 30, and a piston member 40. The grip 10 includes a cylindrical portion 101 and a grip 102 fixed on a lower side of the cylindrical portion 101, and the cylindrical portion 101 is horizontal and includes a chamber 103 with an opening formed on a front end of the chamber 103, the grip 102 has a control switch 104 and an air inlet segment (not shown) connected with a high pressure air, wherein the valve unit 20 and the cylinder 30 are accommodated in the chamber 103. The valve unit 20 contacts with a rear end of the cylinder 30, and the cylinder 30 is adhered with the cylindrical portion 101 of the body 10 by using adhesive glue. The cylinder 30 includes a room 301 defined therein, such that the piston member 40 moves forward and backward. The cylinder 30 also includes an air passage 302 formed on an inner wall thereof and on a front end of the room 301 to communicate with the valve unit 20, such that the high pressure air flows toward the valve unit 20 through the grip 102. In operation, the control switch 104 on the grip 102 is turned on so that the high pressure air flows into the rear end of the room 301 of the cylinder 30 via the valve unit 20 to push the piston member 40 toward a predetermined position to impact a tool head (not shown), and the piston member 40 is stopped by the tool head, thereafter the high pressure air flows into the front end of the room 301 of the cylinder 30 through the valve unit 20 from the air passage 302 to push the piston member 40, hence the piston member 40 moves backward to impact the valve unit 20 and is stopped by the valve unit 20, thus pushing the piston member 40 forward and backward to operate the conventional pneumatic tool.

However, the cylinder 30 is adhered in the chamber 103 of the cylindrical portion 101 of the body 10 by using the adhesive glue, such that when the piston member 40 hits the tool head and vibrates, the cylinder 30 and the cylindrical portion 101 loose easily. Furthermore, when the valve unit 20, the cylinder 30 or the piston member 40 is broken, the cylinder 30 is removed from the cylindrical portion 101 to replace the cylinder 30 or the piston member 40, thus causing inconvenient replacement.

The present invention has arisen to mitigate and/or obviate the afore-described disadvantages.

### SUMMARY OF THE INVENTION

The primary objective of the present invention is to provide a fixing structure for a cylinder which is fixed in a chamber of a body of a pneumatic tool, wherein a flexible loop fitted on a first rib of the cylinder abuts against the chamber of the cylindrical portion, and at least one positioning element is inserted into at least one orifice of the cylindrical portion of the body, such that the at least one positioning element retains with at least one locking notch of a second rib of the cylinder, hence the cylinder is fixed with the cylindrical portion of the body securely, and the cylinder does not loose to avoid danger and to reduce failure rate.

Another objective of the present invention is to provide a fixing structure for a cylinder which when the valve unit, the cylinder or the piston member is broken, the at least one positioning member is removed easily to replace a new one quickly and easily.

To obtain above-mentioned objective, a fixing structure for a cylinder provided by the present invention is employed to a pneumatic tool and contains: a body, a valve unit, a cylinder, a piston member, and at least one positioning element.

The body includes a horizontally cylindrical portion and a grip connecting with the cylindrical portion, the cylindrical portion has a chamber with an opening formed on a front end of the chamber, the cylindrical portion has at least one orifice passing through one side of the cylindrical portion and communicating with the chamber.

The valve unit is mounted in the chamber, and high pressure air flows toward the valve unit via the body.

The cylinder is secured in the chamber to contact with the valve unit, and the cylinder includes a room defined therein and at least one locking notch formed thereon, wherein each locking notch corresponds to each orifice and does not pass through the room.

The piston member is placed into the room of the cylinder, and the valve unit pushes the high pressure air to flow along the room forward and backward.

The at least one positioning element is inserted into each orifice of the cylindrical portion of the body, such that a part of each of the at least one positioning element retains with each locking notch of the cylinder, thus fixing the cylinder with the cylindrical portion of the body.

### BRIEF DESCRIPTION OF THE DRAWINGS

FIG. 1 is a perspective view showing the exploded components of a fixing structure for a cylinder being applied on a pneumatic tool according to a preferred embodiment of the present invention.

FIG. 2 is a perspective view showing the assembly of the fixing structure for the cylinder being applied on the pneumatic tool according to the preferred embodiment of the present invention.

FIG. 3 is a cross sectional view showing the assembly of the fixing structure for the cylinder being applied on the pneumatic tool according to the preferred embodiment of the present invention.

FIG. 4 is another cross sectional view showing the assembly of the fixing structure for the cylinder being applied on the pneumatic tool according to the preferred embodiment of the present invention.

FIG. 5 is a perspective view showing the exploded components of a fixing structure for a cylinder being applied on a pneumatic tool according to another preferred embodiment of the present invention.

FIG. 6 is a cross sectional view showing the assembly of the fixing structure for the cylinder being applied on the pneumatic tool according to another preferred embodiment of the present invention.

FIG. 7 is a perspective view showing the exploded components of a fixing structure for a cylinder being applied on a pneumatic tool according to another preferred embodiment of the present invention.

FIG. 8 is a cross sectional view showing the assembly of the fixing structure for the cylinder being applied on the pneumatic tool according to another preferred embodiment of the present invention.

FIG. 9 is a perspective view showing the exploded components of a fixing structure for a cylinder being applied on a pneumatic tool according to another preferred embodiment of the present invention.

FIG. 10 is a cross sectional view showing the assembly of the fixing structure for the cylinder being applied on the pneumatic tool according to another preferred embodiment of the present invention.

FIG. 11 is a cross sectional view showing the assembly of a conventional pneumatic tool.

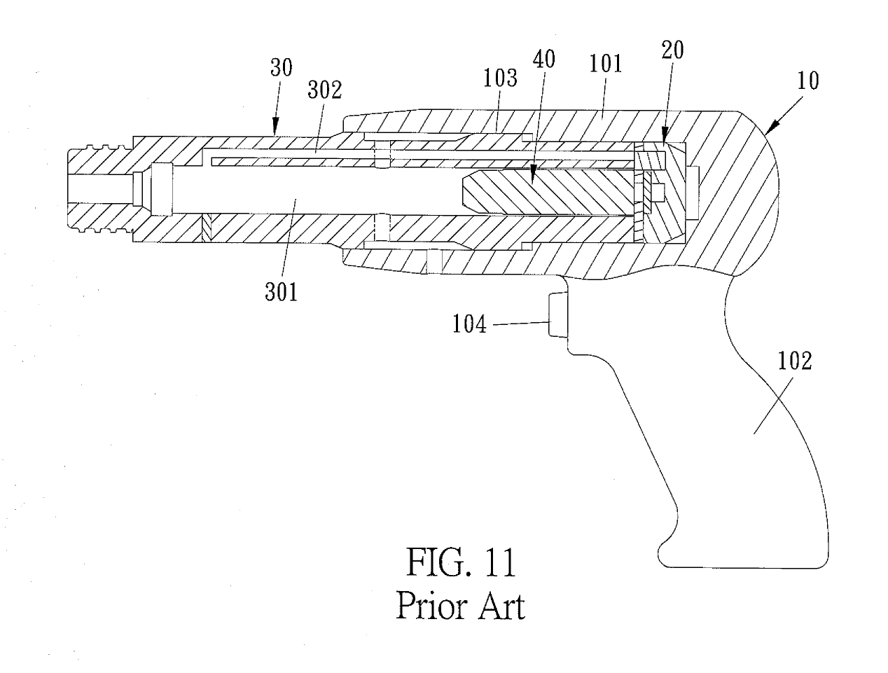

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

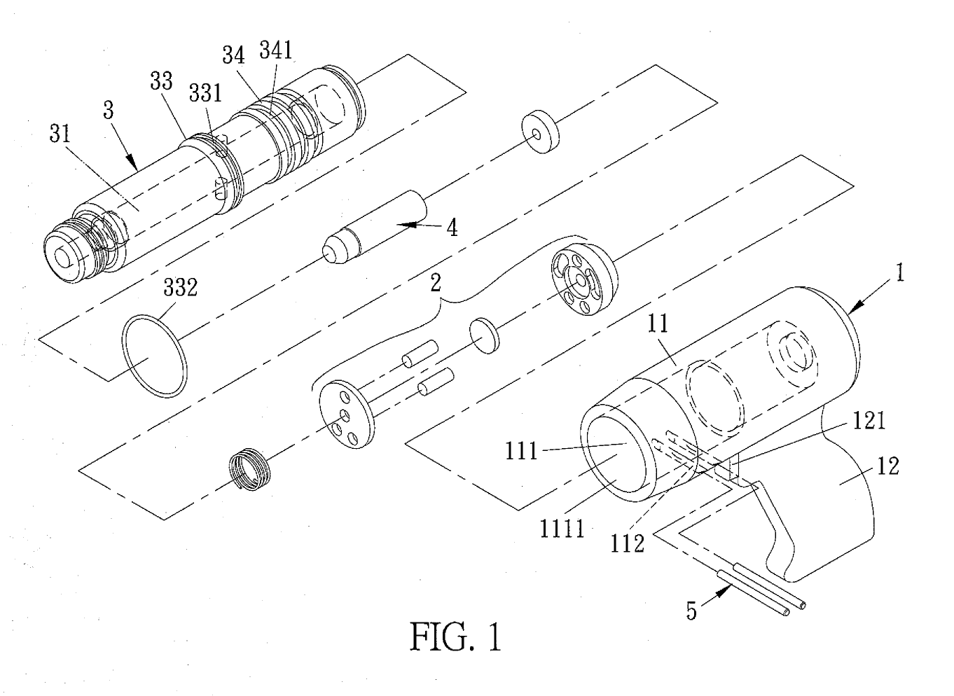

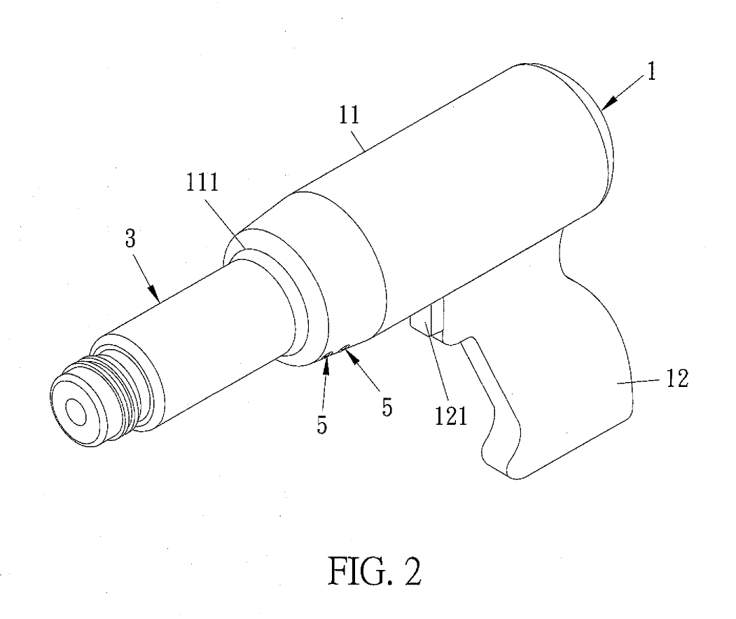

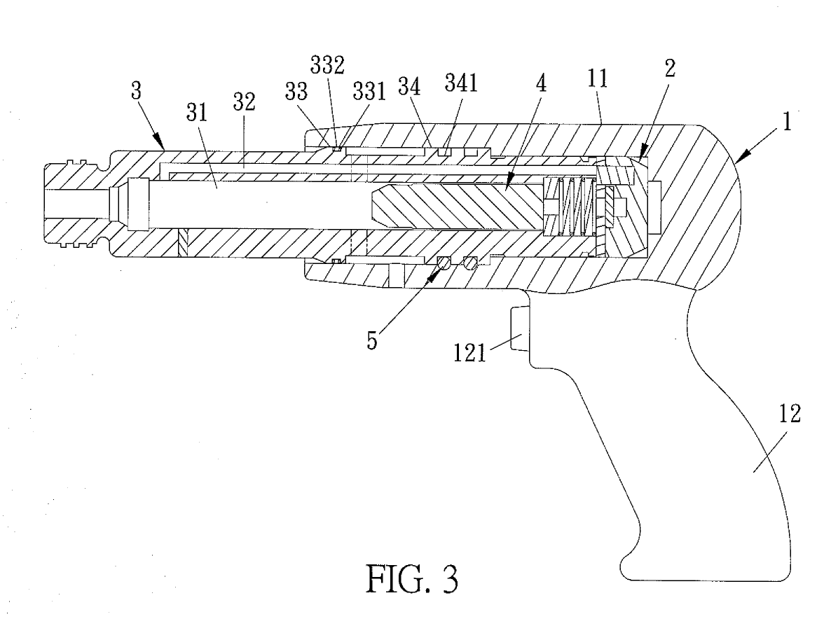

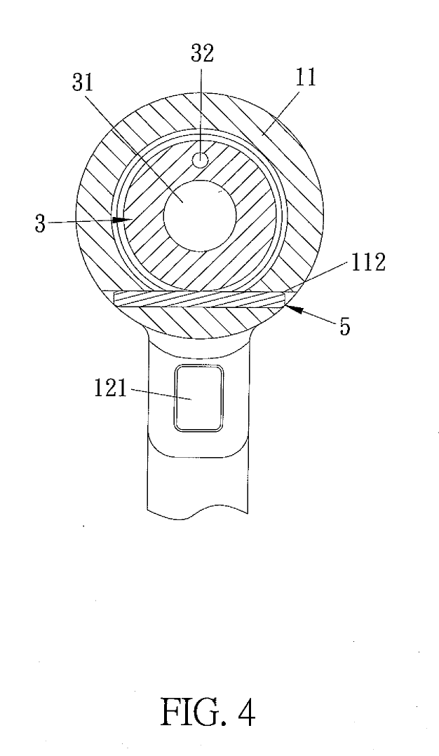

With reference to FIGS. 1 to 4, a fixing structure for a cylinder according to a preferred embodiment of the present invention is employed to a pneumatic tool, wherein the pneumatic tool comprises: a body 1, a valve unit 2, a cylinder 3, a piston member 4, and two positioning elements 5, wherein the body 1 includes a cylindrical portion 11 and a grip 12 disposed on a lower side of the body 1, wherein the cylindrical portion 11 is horizontal and has a chamber 111 with an opening 1111 formed on a front end of the chamber 111, the cylindrical portion 11 has two orifices 112 passing through one side of the cylindrical portion 11 and communicating with the chamber 111, and the grip 12 has a control switch 121 and an air inlet segment (not shown) connecting with high pressure air. The valve unit 2 is mounted in the chamber 111, and the high pressure air flows toward the valve unit 2 via the grip 12. A part of the cylinder 3 is secured in the chamber 111 so that the valve unit 2 contacts with a rear end of the cylinder 3, and the cylinder 3 includes a room 31 defined therein and includes an air passage 32 formed in an inner wall thereof and on a front end of the room 31 to communicate with the valve unit 2. The cylinder 3 also includes a first rib 33 and a second rib 34 which are arranged around an outer wall of the cylinder 3, wherein the first rib 33 has a peripheral slot 331 for fitting with a flexible loop 332, such that the flexible loop 332 abuts against the chamber 111 of the cylindrical portion 11 proximate to the opening 1111, thus contacting the cylinder 3 with the body 1 tightly. The second rib 34 has two locking notches 341 formed thereon, wherein each locking notch 341 is circular and corresponds to each orifice 112 and does not pass through the room 31. The piston member 4 is placed into the room 31 of the cylinder 3, and the valve unit 2 pushes the high pressure air to flow along the room 31 forward and backward. Each positioning element 5 is an insertion bolt inserting into each orifice 112 of the cylindrical portion 11 of the body 1 to retain with each locking notch 341 of the second rib 34 of the cylinder 3, such that the cylinder 3 is connected with the cylindrical portion 11 of the body 1 securely.

In assembly, the piston member 4 is mounted in the room 31 of the cylinder 3, the flexible loop 332 is fitted on the first rib 33 of the cylinder 3, and the valve unit 2 and the cylinder 3 are fixed in the chamber 111 of the cylindrical portion 11 of the body 1 in order, such that the valve unit 2 contacts with the rear end of the cylinder 3, the flexible loop 332 retains in the chamber 111 of the cylindrical portion 11 proximate to the opening 1111, and the two positioning elements 5 are inserted into the two orifices 112 of the cylindrical portion 11 of the body 1 and are partially extend into the chamber 111 of the cylindrical portion 11 of the body 1 to retain in the two locking notches 341 of the second rib 34 of the cylinder 3, thus connecting the body 1 with the cylinder 3.

After turning on the control button 121 on the grip 12, the high pressure air is controlled by the valve unit 2 to flow into the rear end of the room 31 of the cylinder 3 and to push the piston member 4 toward a first predetermined position to impact a tool head (not shown), hence the piston member 4 is stopped by the tool head, and the high pressure air is controlled by the valve unit 2 to changeably flow into the front end of the room 31 of the cylinder 3 and to push the piston member 4 backward toward a second predetermined position to impact the valve unit 2, such that the piston member 4 is stopped by the valve unit 2 and is pushed by the high pressure air.

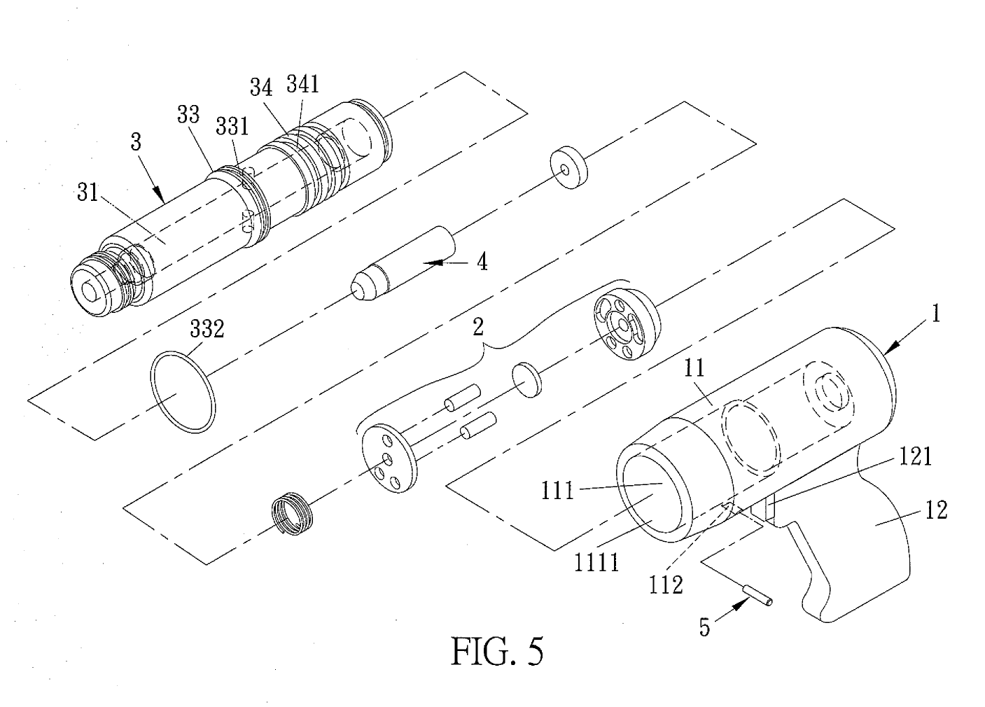

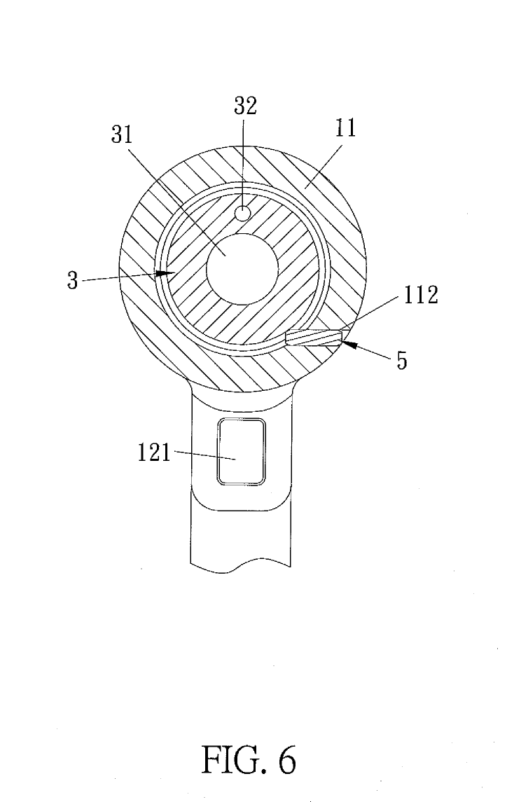

Referring to FIGS. 5 and 6, in another embodiment, an orifice 112 is formed on one side of the cylindrical portion 11 of the body 1 to communicate with the chamber 111, and the second rib 34 of the cylinder 3 has at least one locking notch 341, wherein a positioning element 5 is inserted into the orifice 112 of the cylindrical portion 11 of the body 1 so that one end of the positioning element 5 retains in the at least one locking notch 341 of the second rib 34 of the cylinder 3, thus fixing the cylinder 3 with the cylindrical portion 11 of the body 1 fixedly.

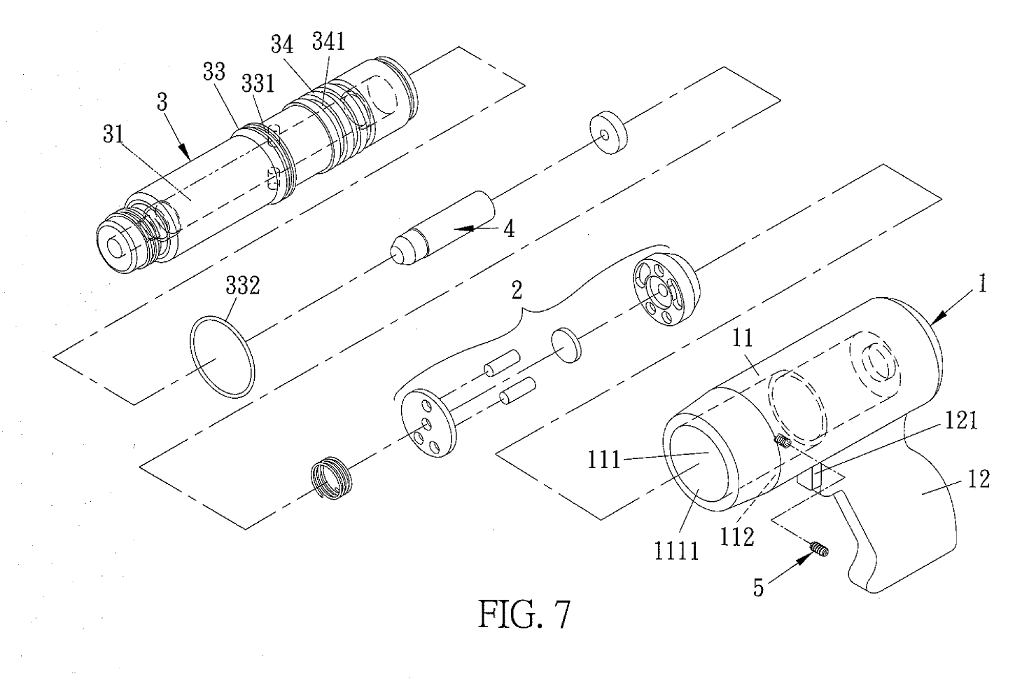

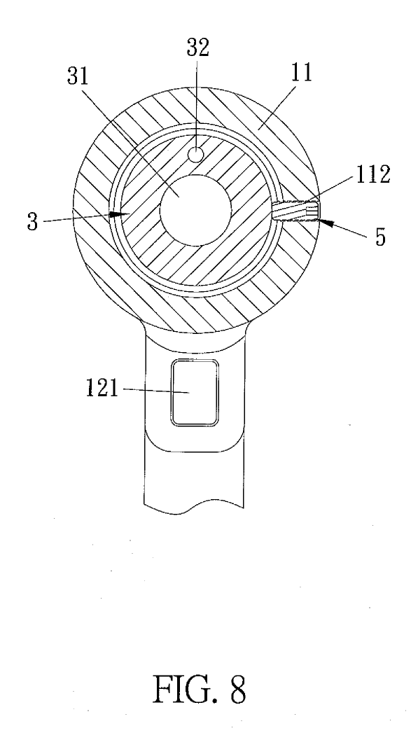

As shown in FIGS. 7 and 8, in another embodiment, an orifice 112 is formed on one side of the cylindrical portion 11 of the body 1 to communicate with the chamber 111, wherein the orifice 112 is a threaded orifice, and the second rib 34 of the cylinder 3 has at least one locking notch 341, wherein a positioning element 5 is a screw bolt which is screwed with the orifice 112 of the cylindrical portion 11 of the body 1 so that one end of the positioning element 5 retains in the at least one locking notch 341 of the second rib 34 of the cylinder 3, thus fixing the cylinder 3 with the cylindrical portion 11 of the body 1 securely.

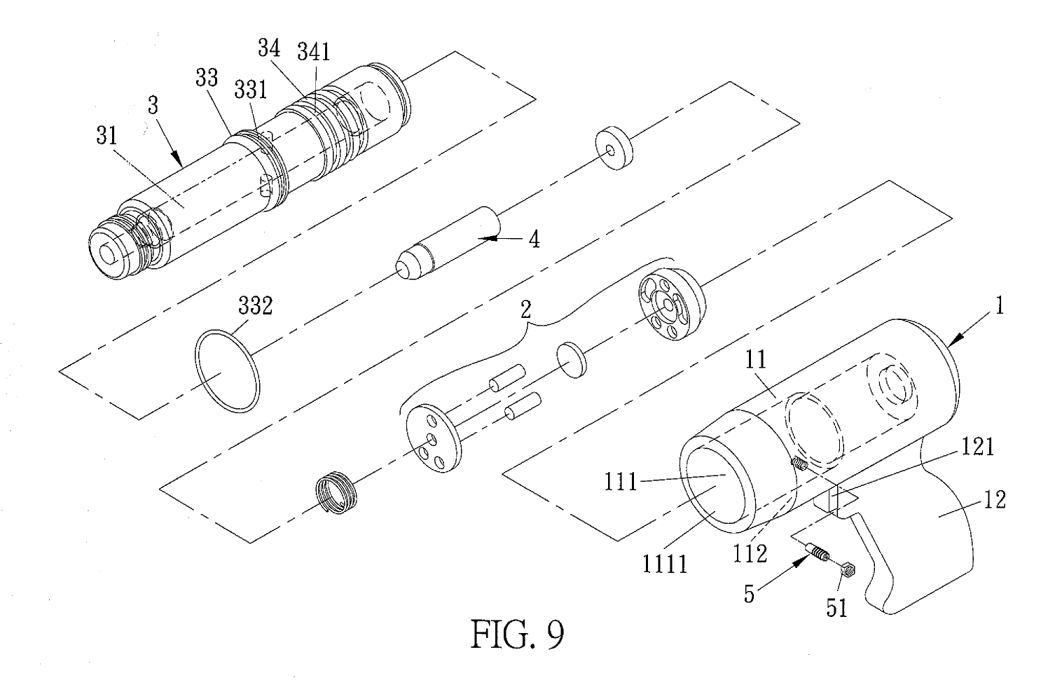

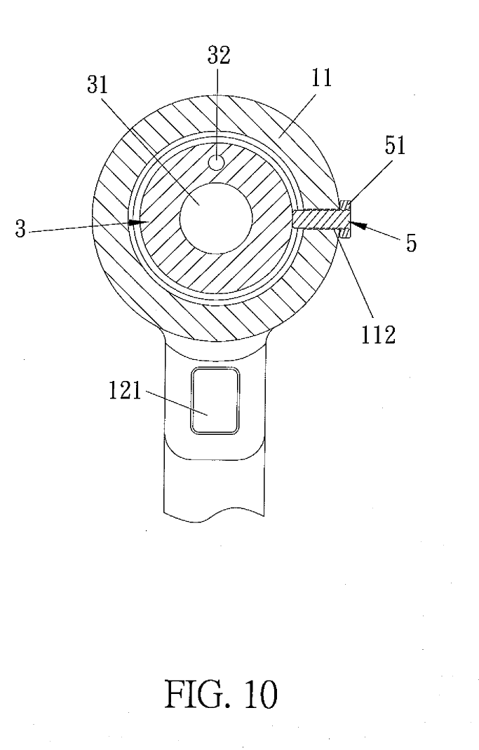

With reference to in FIGS. 9 and 10, in another embodiment, an orifice 112 is formed on one side of the cylindrical portion 11 of the body 1 to communicate with the chamber 111, wherein the orifice 112 is a threaded orifice, and the second rib 34 of the cylinder 3 has at least one locking notch 341, wherein a positioning element 5 is a bolt which is screwed with the orifice 112 of the cylindrical portion 11 of the body 1 so that one end of the positioning element 5 retains in the at least one locking notch 341 of the second rib 34 of the cylinder 3, and a part of the positioning element 5 exposes outside the cylindrical portion 11 of the body 1 to screw with a nut 51, thus fixing the cylinder 3 with the cylindrical portion 11 of the body 1 securely.

Thereby, the cylinder 3 is fixed in the chamber 111 of the cylindrical portion 11 of the body 1, and the flexible loop 332 fitted on the first rib 33 of the cylinder 3 retains with the chamber 111 of the cylindrical portion 11, at least one positioning element 5 is inserted into the orifice 112 of the cylindrical portion 11 of the body 1 and partially extends into the chamber 111 of the cylindrical portion 11 of the body 1 to retain in the at least one locking notch 341 of the second rib 34 of the cylinder 3, thus connecting the body 1 with the cylinder 3 securely. Accordingly, the cylinder 3 does not loose to avoid danger and to reduce failure rate. Preferably, when the valve unit 2, the cylinder 3 or the piston member 4 is broken, the at least one positioning member 5 is removed easily to replace a new one quickly and easily.

While various embodiments in accordance with the present invention have been shown and described, it is clear to those skilled in the art that further embodiments may be made without departing from the scope of the present invention.

What is claimed is:

1. A fixing structure for a cylinder being employed to a pneumatic tool, and the pneumatic tool comprising:
a body including a horizontally cylindrical portion and a grip connecting with the cylindrical portion, the cylindrical portion having a chamber with an opening formed on a front end of the chamber, the cylindrical portion having at least one orifice passing through one side of the cylindrical portion and communicating with the chamber;
a valve unit mounted in the chamber, and high pressure air flowing toward the valve unit via the body;
a cylinder secured in the chamber to contact with the valve unit, and the cylinder including a room defined therein and at least one locking notch formed thereon, wherein each locking notch corresponds to each orifice and does not pass through the room;
a piston member placed into the room of the cylinder, and the valve unit pushing the high pressure air to flow along the room forward and backward; and
at least one positioning element inserted into each orifice of the cylindrical portion of the body, such that a part of each of the at least one positioning element retains with each locking notch of the cylinder, thus fixing the cylinder with the cylindrical portion of the body.

2. The fixing structure for the cylinder as claimed in claim 1, wherein the cylinder also includes a first rib and a second rib which are arranged around an outer wall of the cylinder, wherein the first rib has a peripheral slot for fitting with a flexible loop, and the second rib has the at least one locking notch formed thereon.

3. The fixing structure for the cylinder as claimed in claim 1, wherein the flexible loop abuts against the chamber of the cylindrical portion proximate to the opening, thus contacting the cylinder with the body tightly.

4. The fixing structure for the cylinder as claimed in claim 2, wherein the flexible loop abuts against the chamber of the cylindrical portion proximate to the opening, thus contacting the cylinder with the body tightly.

5. The fixing structure for the cylinder as claimed in claim 1, wherein each locking notch is circular.

6. The fixing structure for the cylinder as claimed in claim 2, wherein each locking notch is circular.

7. The fixing structure for the cylinder as claimed in claim 1, wherein each positioning element is an insertion bolt.

8. The fixing structure for the cylinder as claimed in claim 1, wherein each orifice of the cylindrical portion of the body is a threaded orifice, and each positioning element is a screw bolt.

9. The fixing structure for the cylinder as claimed in claim 1, wherein each orifice of the cylindrical portion of the body is a threaded orifice, each positioning element is a screw bolt, and a part of the positioning element exposes outside the cylindrical portion of the body to screw with a nut.

10. The fixing structure for the cylinder as claimed in claim 1, wherein the cylinder also includes an air passage formed on an inner wall thereof and on a front end of the room to communicate with the valve unit.

11. The fixing structure for the cylinder as claimed in claim 1, wherein a flexible loop is fitted on the cylinder to retain with the chamber of the cylindrical portion of the body.
